(19) United States
(12) Patent Application Publication
(10) Pub. No.: US 2025/0117749 A1
(43) Pub. Date: Apr. 10, 2025

(54) METHODS FOR INTEGRATING COMPUTERIZED SYSTEMS INTO WORKFLOWS

(71) Applicant: Benjamin Traub, Englewood, FL (US)

(72) Inventor: Benjamin Traub, Englewood, FL (US)

(73) Assignee: Inspira AI Corp, Las Vegas, NV (US)

(21) Appl. No.: 18/907,623

(22) Filed: Oct. 7, 2024

Related U.S. Application Data
(60) Provisional application No. 63/588,689, filed on Oct. 7, 2023.

(51) Int. Cl. G06Q 10/10

(52) U.S. Cl. CPC G06Q 10/103

(57) ABSTRACT

The invention involves a computerized system that integrates autonomous agents into digital project management workflows, enabling seamless collaboration with human team members. It provides an interface where agents are treated like human team members, allowing for task assignment, communication, and collaboration without altering existing workflows. Agents can have names, titles, and skills and can access workflow data to trigger actions like sending alerts or initiating function calls. The system supports single or multi-step task execution by agents, maintaining a unified workflow and tracking performance of both humans and agents for improved oversight, enhancing collaboration and productivity.

### BACKGROUND

The present invention generally relates to computerized systems that are constructed to integrate autonomous Agents into project management workflows.

Workflows that are executed in the context of digital project management typically include the assignment of team members to tasks.

Team members communicate about the tasks through a comment system, through which members delegate, collaborate, and report on the progress of work.

The advent of LLM-powered agents presents the opportunity to incorporate agents into project management workflows, yet prior attempts have a separation between the agents and the human workflow, such that the incorporation of agents into the workflow requires learning new and unfamiliar interfaces, and collaborative work between humans and agents is different from previously established workflows between humans, such that the new workflows require the development of new project management software interfaces and upgraded skills training for team members.

### SUMMARY OF INVENTION

The present invention incorporates an interface where the human team members and agents can communicate about, or collaborate together, to complete tasks.

According to an aspect of the present invention, agents may be integrated into the project management workflow in a manner where collaboration between humans and agents requires no learning or adaptation by the humans, as the agents are presented to the humans in the project management interface the same way that other human team members might be presented.

According to another aspect of the present invention, agents may have human-like characteristics, such as avatars, names, titles and skills.

According to another aspect of the present invention, humans may utilize the system to plan and initiate production processes by Agents.

According to another aspect of the present invention, Agents may be assigned to tasks in the same method used to assign other human team members to a task.

According to another aspect of the present invention, humans who review the tasks within the system can see the lists of assigned team members, which might consist of a combination of humans and Agents.

According to another aspect of the present invention, a human may communicate with an Agent in the same messaging systems that humans might use to interact with other humans.

According to another aspect of the present invention, humans who review the tasks within the system can see the historical communications between agents and humans.

According to another aspect of the present invention, humans may also utilize the system to perform tasks of their own and may be involved in the review and revision process of output produced by Agents.

According to another aspect of the present invention, the data related to the performance of the humans and Agents may be reported on to give visibility into, or allow an investigation into the work patterns and outputs of the humans and agents.

According to another aspect of the present invention, the agents have access to workflow-related information, can interpret the information utilizing one or more of; prediction of future events, detection of real-time events or identifying historical patterns or events.

According to another aspect of the present invention, the agents can utilize interpreted data to trigger autonomous events, such as the sending of alerts to humans or other agents, or triggering function calls or API requests.

According to another aspect of the present invention, computerized systems allow certain work to be performed autonomously by executing single-step, or multi-step chain-of-thought or tree-of-thought workflows to assess information and come to conclusions and/or produce productive output.

### BRIEF DESCRIPTION OF THE DRAWINGS

FIG. 1 illustrates an overview of the system, where humans 1 and Agents 2 engage with the computerized project management workflow system. Data may flow from a human's computing device to an interface (such as an input field), then through a network to storage, or if the data is derived from a user's behavior (such as focusing on a particular application or website), the data can flow directly through software on the user's device that has been configured to capture a user's focus window using a library such as get-windows which is a node.js library.

FIG. 2 illustrates an interface where agents and humans can be assigned to a task.

FIG. 3 illustrates an interface where humans can review the list of human and agent team members assigned to a task.

FIG. 4 illustrates an example of a shared communication interface used by humans and Agents.

FIG. 5 illustrates data (such as a message) flowing from agents 99 and a computing device of humans 99 flowing through a network 99 to the classification engine 99, which stores the inputs in a classified data structure, such as a relational database.

FIG. 6 illustrates the flow of data from storage in the classification engine 99, through a network 99 to the interpretation engines 99 for one or more of prediction 99, detection 99 or recollection 99, being processed by a computing instance 99 consisting of the expected hardware such as CPU and memory.

FIG. 7 illustrates triggers flowing through a network 99 from the interpretation engines to the Intervention engine 99.

FIG. 8 illustrates data flowing through a network 99 from the interpretation engines to the Visualization engine 99.

FIG. 9 illustrates data flowing through a network 99 from the interpretation engines to the Inspiration engine 99.

FIG. 10 illustrates messages flowing through a network 99 from the Intervention engine to other humans.

FIG. 11 illustrates the high-level construction of an LLM-powered messaging agent capable of communicating with humans or other agents.

FIG. 12 illustrates the high-level construction of the interpretation engines 33.

FIG. 13 illustrates the high-level construction of computer application software 46 that may be installed on a Human's 1 computing device.

FIG. 14 illustrates the high-level operation of intervention engine 8.

FIG. 15 illustrates the high-level operation of investigation engine 7.

FIG. 16 illustrates the high-level operation of Inspiration Engine 10.

### DETAILED DESCRIPTION

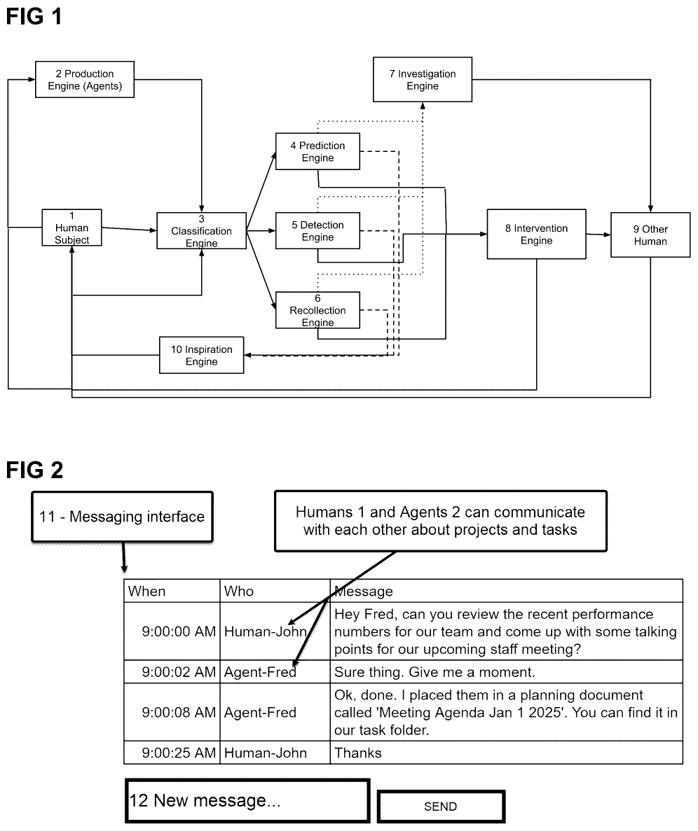

FIG. 1 illustrates an overview of the system backend, where humans 1 and autonomous Agents 2 engage with the project management workflow system, with inputs and outputs to and from being stored in a classification engine 3 where the data is stored in a classified manner, such as in a relational database, then made available to the interpretation engines for predicting 4 future events, detecting real-time events 5, or identifying historical events or patterns 6, where the interpretations are passed to a visualization engine 7 for reporting, or where the interpretations are used to trigger interventions 8 such as messages to agents or humans, or to trigger function calls or API requests, or messages to other humans 9 or to send requests to inspiration engine 10 to trigger a plurality of Agents that synthetically reenact actions that resemble human social dynamics amongst themselves as they compete in gamification to perform in leaderboards, alongside humans.

In one embodiment, the elements of FIG. 1 may act as a messaging and feedback loop, where an agent or a human performs an action, such as sending a message, where the message is stored in the classification engine 3. The data is passed to the interpretation engines for predicting 4, detecting real-time events 5, or identifying historical events or patterns 6, any of which may process the message and identify if the message should be optimized or flagged, such as for priority. These interpretations may result in triggering an intervention 8 such as alert to another human 9, or sent to human 1 or an agent 2. The human 1 or agent 2 may then respond to the message, where the messaging cycle may repeat itself.

FIG. 2 illustrates a messaging interface 11 demonstrating how humans 1 and agents 2 can communicate with each other about tasks.

In one embodiment, an LLM-powered chat agent 2 can take in contextual information from the backend systems to obtain contextual awareness using RAG or other programmatic methods to retrieve relevant information from the data stored in the classification engine 4, or if the system initializes the agent, the system may supply the agent with the contextual information without the agent needing to retrieve it. The agent 2 can be empowered to trigger function calls and API requests to perform tasks. New messages 12 can be input by humans, whereas agents may use only backend systems to send messages, similar to the workflow described in 0031.

In another embodiment, the messaging interface 11 is comprised of a voice-to-voice interface, where an agent 2 would utilize TTS and STT technology.

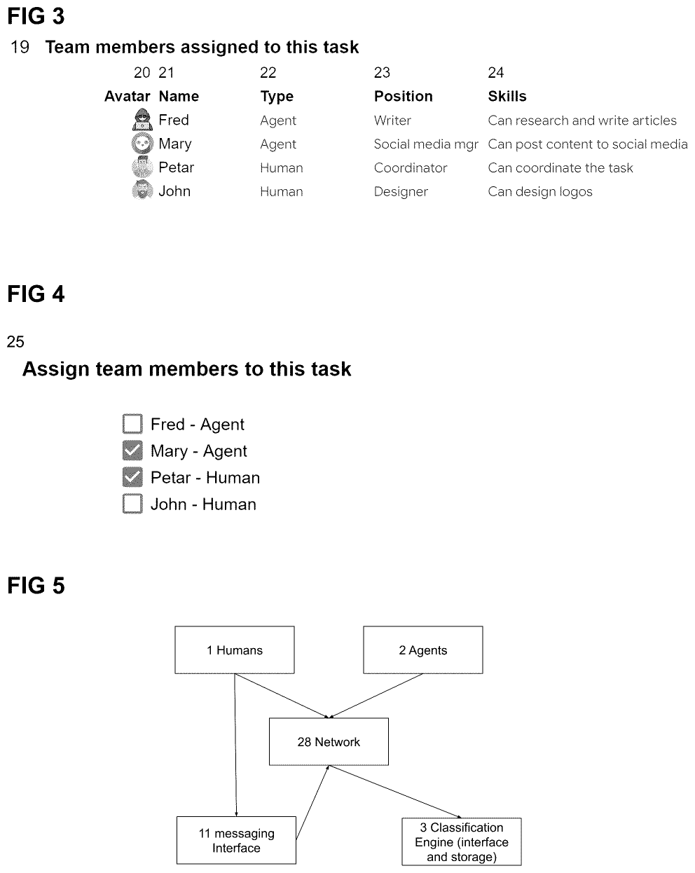

FIG. 3 illustrates how humans might observe the list of team members 19 who are assigned to tasks, whether humans or agents.

In one embodiment a human might load the interface 19, navigate to the list of assignees to reveal the list, if not already visible. Humans or agents might observe information about the assignees, such as an optional avatar 20 or photo of the user, the user's name 21, the type 22, whether human or agent, the position 23 and their skills 24.

In another embodiment a human might load the interface 19, navigate to the list of assignees to reveal the list, if not already visible. Humans or agents might observe information about the assignees, such as an optional avatar 20 or photo of the user, the user's name 21, the type 22, whether human or agent, the position 23 and their skills 24. Some of this user information might be combined or hidden if not always necessary for it to be revealed.

FIG. 4 illustrates how humans might assign humans or agents to a task 25.

In one embodiment a human might load the interface, navigate to the assignment section 25, if not already visible, and then select assignees, either humans or agents.

FIG. 5 illustrates how data might flow from an agent 2, or from a human's 1 computing device, through a network 28 to the Classification Engine 3. It also illustrates how a human could make an input into the messaging interface 11 with that data directed through a network 28 to the Classification Engine 3.

In one embodiment, a human might install software on their computing device that can capture data such as the software applications or websites the human uses, utilizing a library such as get-windows, or capture user inputs such as keystrokes or mouse activity using a library such as iohook, then have the captured data automatically flow through a network 28 to the Classification Engine 3.

In another embodiment, a human 1 might type messages into a messaging interface 11, and have that flow through a network 28 to the Classification Engine 3.

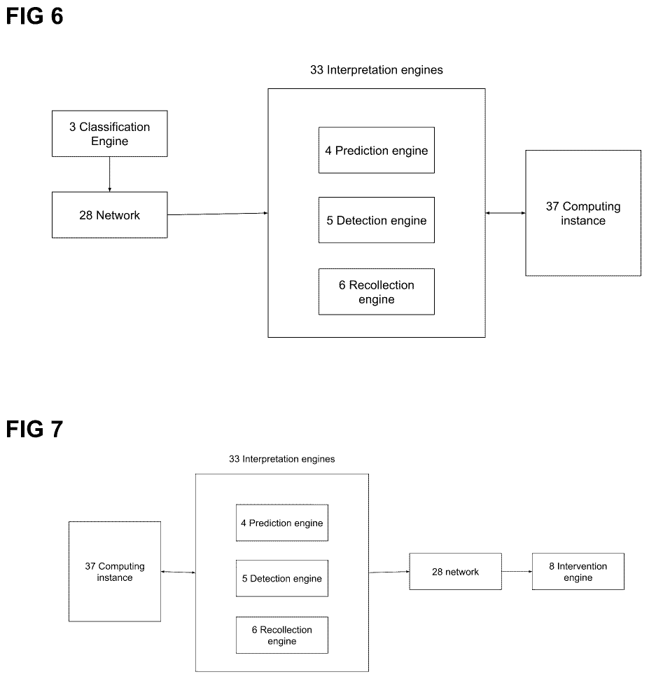

FIG. 6 illustrates how data might flow from storage in the classification engine 3 through a network 28 to the interpretation engines 33, to be interpreted by any of the prediction engine 4, detection engine 5 or recollection engine 6, executed by a computing instance 37 comprising or standard computing resources such as CPU, memory or storage.

In one embodiment, the data in the classification engine 31 might be a message previously generated by a human or agent, where the data flows through a network 28 to the interpretation engines 33, to be interpreted by any of the prediction engine 4, detection engine 5 or recollection engine 6, executed by a computing instance 37 comprising or standard computing resources such as CPU, memory or storage.

FIG. 7 illustrates how data that is interpreted by the interpretation engines 33 might flow through a network 28 to the intervention engine 8.

In one embodiment, the interpreted data from the interpretation engines 33 might be a message generated by a human 1 or agent 2, where the message is detected to be a high priority action-item by one or more of the interpretation engines 33. The message is flagged as such and the data flows through a network 28 to the intervention engine where it is sent to the intended recipient.

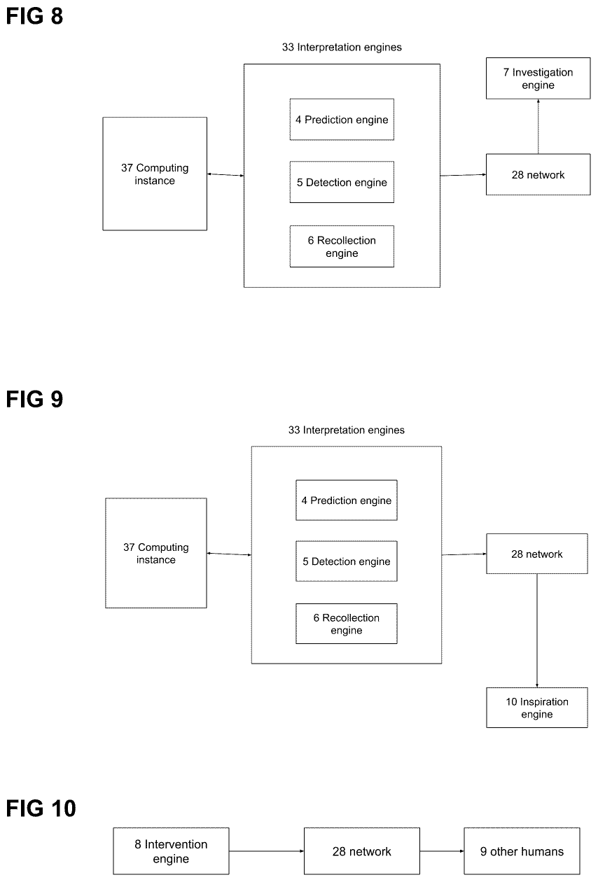

FIG. 8 illustrates how data that is interpreted by the interpretation engines 33 might flow through a network 28 to the investigation engine 7.

In one embodiment, the interpreted data from the interpretation engines 33 might be a message generated by a human 1 or agent 2, where the message is detected by the detection engine 5 to be a high priority action-item by one or more of the interpretation engines 33. The message is flagged as such and the data flows through a network 28 to the investigation engine where it may be observed in the context of reporting.

FIG. 9 illustrates how data that is interpreted by the interpretation engines 33 might flow through a network 28 to the inspiration engine 10.

In one embodiment, the interpreted data from the interpretation engines 33 might be a message generated by a human 1 or agent 2, where the message is predicted by the prediction engine 4 that the high priority action-item will put stress on the recipient. The message is flagged as such and the data flows through a network 28 to the inspiration engine where it flags an agent to have a chat with the recipient about to encourage them to press in and get it done.

FIG. 10 illustrates how messages are sent from the intervention engine through a network 28 to other humans 9 who might not be assignees of a task, such as a manager.

In one embodiment, the intervention engine sends a message through a network 28 to other humans 9 who might not be assignees of a task, such as a manager, to alert them to the high-priority task assignment as a way to report on the tasks progress.

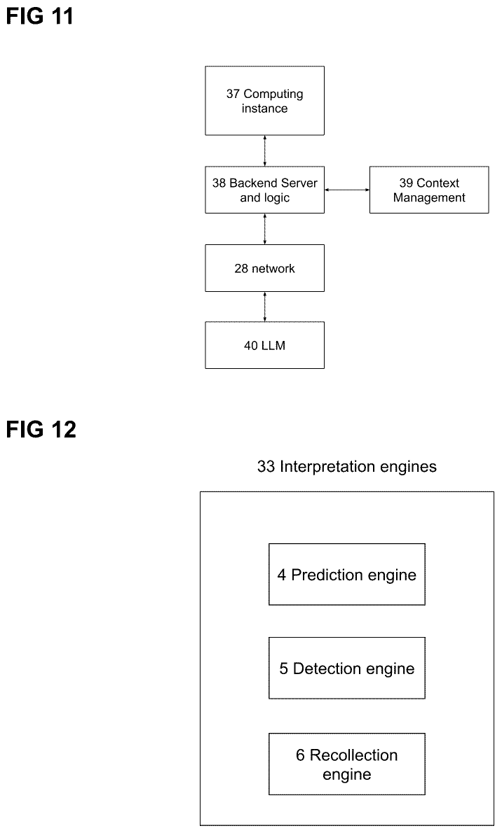

FIG. 11 illustrates how an agent 1 might be constructed.

In one embodiment, an agent has business logic on a backend server 38 that guides and directs the operation of the agent. The business logic is executed by a computing instance 37 comprising of standard computing resources such as CPU, memory or storage. Requests may be made of an LLM 40 utilizing contextual information from a context management 39 system.

In another embodiment, an agent 2 is capable of function calling or making API requests as a way to communicate with team members or complete tasks.

FIG. 12 illustrates the construction of the interpretation engines 33, including the prediction engine 4, the detection engine 5 and the recollection 6.

In one embodiment, a high volume of well-structured time series data from the classification engine 3, is made available to the prediction engine 4, which can, depending on the type and shape of the data, use models such as linear regression, RNNs, or SVMs, to predict future behaviors and events.

In another embodiment, the data from the Classification Engine 3 is made available to the Detection Engine 5, which can use predefined criteria to identify real-time events of importance, such as the late-check-in of an employee, or a failed function call made by an Agent.

In another embodiment, the data from the Classification Engine 3 is made available to the Recollection Engine 6, which can use predefined criteria to analyze the data for important patterns or events.

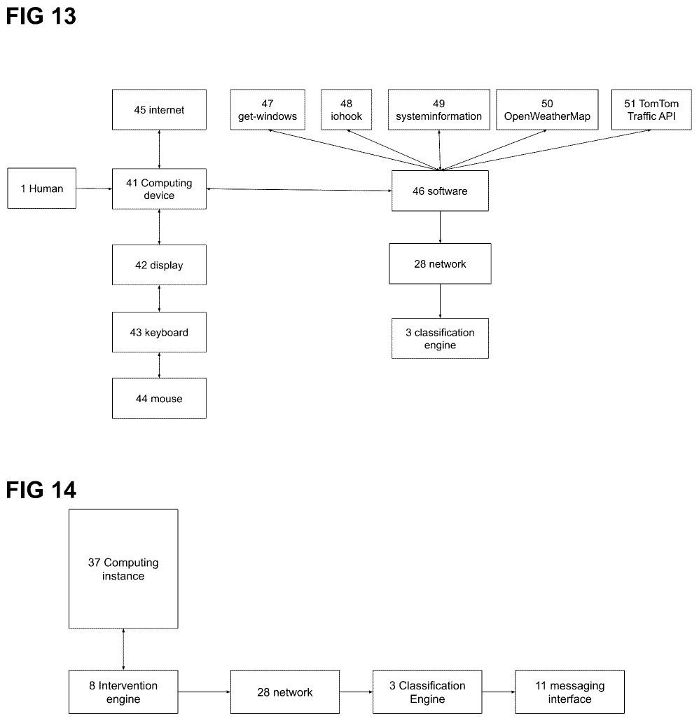

FIG. 13 illustrates how the human 1 interacts with their local computing device 41, viewing websites from the internet 45 on their display 42 and accessing software applications installed on their computing device 41. Data from this activity is captured by the desktop software 46 that is equipped with the capability of capturing the screens the human has focused on utilizing a library such as get-windows 47. When the human 1 makes inputs through their keyboard 43 and mouse 44, this input data is captured by the desktop software 46 that is equipped with the capability of capturing the user input utilizing a library such as iohook 48. While the human 1 uses the desktop software 46, it may also capture system data related to available memory, storage, wifi, network and the like. This data may be captured by a library such as systeminformation. While the human 1 uses the desktop software 46, it may also capture environmental data such as weather or traffic by utilizing APIs such as OpenWeatherMap and Tom Tom Traffic API. The data captured by the desktop software flows through a network 28 into the classification engine 3.

In one embodiment, the human interacts with their local computing device 41, viewing websites from the internet 45 on their display 42 and accessing software applications installed on their computing device 41. Data from this activity is captured by the desktop software 46 that is equipped with the capability of capturing the screens the human has focused on, utilizing libraries such as get-windows 47. When the human 1 makes inputs through their keyboard 43 and mouse 44, this input data is captured by the desktop software 46 that is equipped with the capability of capturing the user input by utilizing libraries such as iohook 48. While the human 1 uses the desktop software 46, it may also capture system data related to available memory, storage, wifi, network and the like. This data may be captured by libraries such as systeminformation 49. While the human 1 uses the desktop software 46, it may also capture environmental data such as weather or traffic by utilizing APIs such as OpenWeatherMap 50 and Tom Tom Traffic API 51. The data which is captured by the desktop software may be captured as time series data which then flows through a network 28 into the classification engine 3.

FIG. 14 illustrates the operation of intervention engine 8 where it interacts with computing instance 37 to send messages through a network 28 to be stored in the classification engine 3 and displayed in a messaging interface 11.

In one embodiment, a message is received by intervention engine 8 to be displayed in messaging interface 11. The operation of the intervention engine is executed by computing instance 37 and messages flow through a network 28 to be stored in the classification engine 3 and displayed in a messaging interface 11.

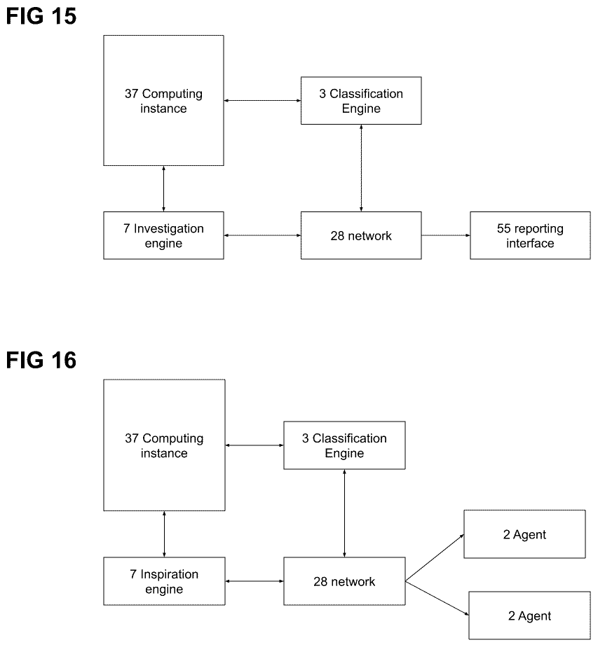

FIG. 15 illustrates the operation of investigation engine 7 where it interacts with computing instance 37 to retrieve reporting data from classification engine 3 through a network 28 and transmits reporting data to be displayed in a reporting interface 55.

In one embodiment, reporting data is retrieved by the investigation engine 7 through a network 28 from the classification engine 4. The operation of the investigation engine 7 is executed by computing instance 37 and reporting data flows through a network 28 to a reporting interface 55.

FIG. 16 illustrates the operation of inspiration engine 10 where it interacts with computing instance 37 to retrieve related inspiration data from classification engine 3 through a network 28 and transmits inspiration data to agents 2.

In one embodiment, inspiration data is retrieved by inspiration engine 10 through a network 28 from the classification engine 4. The operation of the inspiration engine 10 is executed by computing instance 37 and inspiration data flows through a network 28 to agents 2 who are instructed to compete in a gamified leaderboard, including sending messages to humans 1 to brag about how well they are doing.

What is claimed is:

1. A computerized system for integrating autonomous agents into digital project management workflows, the system comprising:
An interface configured to present autonomous agents as team members alongside human team members, and
A task assignment system configured to assign tasks to autonomous agents using a process identical to that used for assigning tasks to human team members, and
A communication system enabling autonomous agents and human team members to communicate within a shared messaging system, wherein messages between autonomous agents and human team members are visible in a unified communication history, and
Autonomous agents that can perform tasks within the project management workflow, wherein the autonomous agents access workflow-related data, and execute actions based on the data without requiring human intervention.

2. The system of claim 1, wherein the interface further includes visual representations of autonomous agents, wherein each autonomous agent is represented with a name, title, and skills, similar to the human team members, thereby facilitating seamless collaboration between autonomous agents and human team members.

3. The system of claim 1, wherein the communication system is further configured to allow autonomous agents to send messages or initiate API requests or function calls based on detected events, predicted outcomes, or identified historical patterns in the workflow-related data.

4. The system of claim 1, further comprising:
A classification engine configured to store data related to task performance and communication between autonomous agents and human team members, and
An interpretation system configured to process data from the classification engine to identify historical events or patterns, predict future events, and detect real-time occurrences; and
An intervention engine configured to trigger automated actions based on the interpretations provided by the interpretation engine.

5. The system of claim 1, wherein the business logic further supports autonomous agents to execute single or multi-step workflows by autonomously determining the sequence of steps based on historical data analysis, task requirements, and predefined criteria.

6. The system of claim 4, wherein the intervention engine is further configured to send messages to human or agent team members based on the detected priority of tasks, thereby providing enhanced oversight and coordination between human team members and autonomous agents.

7. A method for integrating autonomous agents into a project management workflow, comprising:
Presenting autonomous agents as team members within a project management interface alongside human team members, and
Assigning tasks to autonomous agents using a task assignment process identical to that used for human team members, and
Enabling autonomous agents to access workflow-related data to identify relevant actions, and
Executing actions autonomously by the agents based on the interpretation of the workflow-related data, including sending notifications and triggering function or API calls, and
Providing a unified communication platform where messages between autonomous agents and human team members are visible and accessible to all participants.

8. The method of claim 7, further comprising the step of tracking and reporting the performance of autonomous agents and human team members through a reporting module, which aggregates data from task assignments and communication history to provide insights into overall workflow efficiency.

9. A non-transitory computer-readable medium storing instructions that, when executed by a processor, cause a computerized system to perform the steps of:
Presenting autonomous agents as team members in a project management interface, and
Assigning tasks to both autonomous agents and human team members using a unified process, and
Enabling autonomous agents to interact with human team members through a shared messaging system; and
Executing autonomous actions based on the interpretation of workflow-related data, including sending alerts and initiating function calls.

10. The non-transitory computer-readable medium of claim 9, wherein the instructions further cause the system to:
Analyze task performance data using a classification engine and interpretation engines, and
Predict future workflow events based on historical data; and
Trigger automated actions through an intervention engine, providing real-time adjustments to the project management process.
